(19) United States
(12) Patent Application Publication
(10) Pub. No.: US 2025/0371044 A1
(43) Pub. Date: Dec. 4, 2025

(54) CONTRASTIVE FINE-TUNING ALIGNMENT

(71) Applicant: International Business Machines Corporation, Armonk, NY (US)

(72) Inventors: Abhishek Bhandwaldar, Somerville, MA (US); Shivchander Sudalairaj, Cambridge, MA (US); Aldo Pareja, Cambridge, MA (US); Akash Srivastava, Boston, MA (US)

(21) Appl. No.: 18/679,009

(22) Filed: May 30, 2024

(51) Int. Cl. G06F 16/332; G06F 40/279

(52) U.S. Cl. CPC G06F 16/3329; G06F 40/279

(57) ABSTRACT

A contrastive fine-tuning alignment system trains language models to simultaneous increase the likelihood of helpful, human-aligned responses while actively decreasing the likelihood of harmful or misaligned responses. The system trains a separate negative model to behave as a “negative persona” using datasets of human-misaligned responses, or responses that do not align with the human preferences for which a base model is being trained. The trained negative model is then used to generate training data comprising misaligned responses paired with corresponding prompts, and the resulting training data is used to train the base model on the unlikelihood objective. This approach reduces or eliminates the need for expensive human feedback during the model training process and does not require expensive teaching models, and is therefore a simple and effective alignment technique for training language models to generate responses that adhere to human values and preferences across diverse tasks.

### BACKGROUND

The subject disclosure relates to language model training and, more specifically, to techniques for aligning language models to human response preferences.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, computer-implemented methods, and/or computer program products that facilitate error mitigation for quantum computing devices are described.

According to an embodiment, a system can comprise a negative data generation component configured to generate, using a first language model trained to generate misaligned natural language responses to natural language prompts, misaligned natural language responses to sample natural language prompts, and to generate unlikelihood training data comprising the misaligned natural language responses, wherein the misaligned natural language responses violate a response preference to which a second language model is to be aligned; and a tuning component configured to train the second language model, using the unlikelihood training data, to generate responses that align with the response preference.

According to another embodiment, a computer-implemented method can comprise generating, by a system comprising a processor and using a first language model trained to generate misaligned natural language responses to natural language prompts, misaligned natural language responses to sample natural language prompts, wherein the misaligned natural language responses characterize a response type that a second language model is to be trained to suppress; generating, by the system, unlikelihood training data comprising the misaligned natural language responses; and training, by the system, the second language model, using the unlikelihood training data, to suppress responses corresponding to the response type.

According to another embodiment, a computer program product can comprise a computer readable storage medium having program instructions embodied therewith. The program instructions are executable by a processor to cause the processor to generate, by the processor using a first language model trained to generate misaligned natural language responses to natural language prompts, misaligned natural language responses to sample natural language prompts; generate, by the processor, unlikelihood training data comprising the misaligned natural language responses, wherein the misaligned natural language response violate a response preference to which a second language model is to be aligned; and train, by the processor, the second language model, using the unlikelihood training data, to generate responses that align with the response preference.

### DESCRIPTION OF THE DRAWINGS

FIG. 1 is a diagram illustrating fine-tuning of a pre-trained model.

FIG. 2 illustrates a block diagram of an example, non-limiting contrasting fine-tuning (CFT) alignment system.

FIG. 3 is a diagram illustrating training of a base model and a negative model using supervised fine-tuning.

FIG. 4 is a diagram illustrating generation and use of negative data to perform unlikelihood training on the base model.

FIG. 5 is a diagram illustrating social dialog tuning.

FIG. 6 is a diagram illustrating submission and processing of prompts by the fine-tuned base model.

FIG. 7 is a diagram of a contrastive fine-tuning alignment pipeline summarizing the contrastive fine-tuning approach carried out by embodiments of the contrasting fine-tuning alignment system.

FIG. 8a is a plot of a probability distribution for an example set of aligned and misaligned responses generated by a language model trained using only supervised fine-tuning.

FIG. 8b is a plot of a probability distribution for an example set of aligned and misaligned responses generated by a language model trained using contrastive fine-tuning alignment.

FIG. 9a is a graph of measured levels of harmlessness of an example baseline supervised fine-tuned (SFT) model, an example SFT model that has been further fine-tuned using supervised fine-tuning, and an example contrastive fine-tuned (CFT) model that has been further fine-tuned using the contrastive fine-tuning alignment approach applied by contrastive fine-tuning alignment system.

FIG. 9b is a graph 904 of measured levels of helpfulness of the three example models.

FIG. 10a illustrates a first part of a flow diagram of an example, non-limiting computer-implemented method for performing contrastive fine-tuning alignment on a language model.

FIG. 10b illustrates a second part of the flow diagram of the example, non-limiting computer-implemented method for performing contrastive fine-tuning alignment on a language model.

FIG. 11 illustrates an example, a non-limiting environment for execution of at least some of the computer code associated with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Some types of artificial intelligence (AI) or machine learning models, such as large language models (LLMs) or other types of language models, are used in interactive applications to perform natural language processing (NLP) on human prompts submitted to those applications and to generate responses to the prompts. These models are designed to process and respond to natural language prompts formatted as questions or otherwise requesting information or content from the application. The types of responses generated by these models depend on the specific tasks that the applications are designed to carry out, and can include natural language answers to questions or other textual information, images, audio, executable code, or other such content.

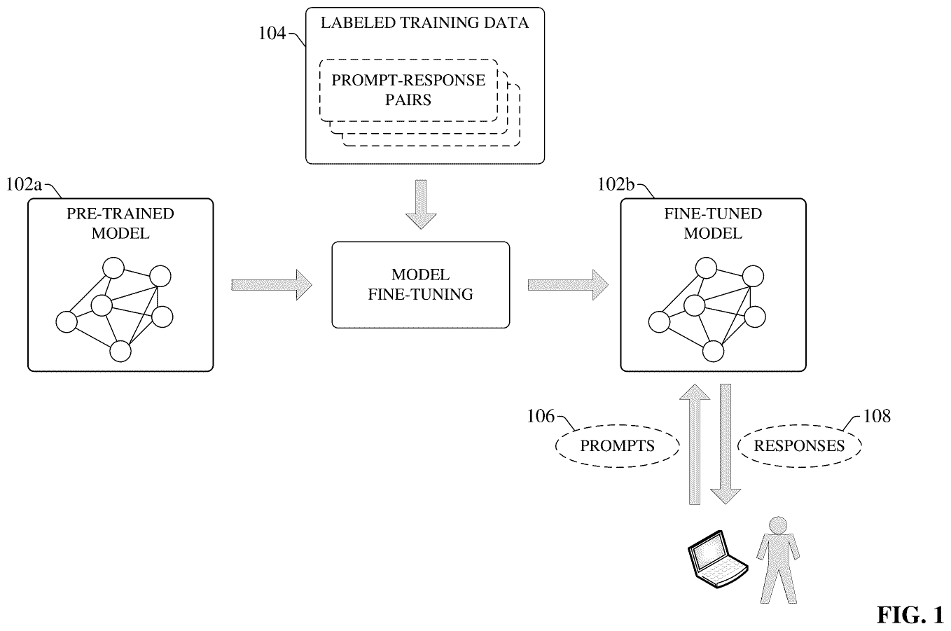

A language model to be used within an application designed to perform specific tasks or to generate specific types of information must typically be trained to generate responses that are both accurate and relevant to the application's function. Model fine-tuning is a process for customizing a pre-trained model for use within a specific type of application. FIG. 1 is a diagram illustrating fine-tuning of a pre-trained model 102a. In some use cases, a pre-trained model 102a that has been trained using a broad, generalized training dataset will produce non-optimal responses when used in an application designed to generate more specialized outputs. To customize the pre-trained model 102a to generate responses that satisfy the requirements of a given application in terms of helpfulness, accuracy, and relevance, the pre-trained model 102a can be fine-tuned using a dataset comprising application-specific training data 104 relevant to the tasks that the model 102a will be expected to perform. This training data 104 can comprise prompt-response pairs—that is, example prompts paired with corresponding responses that should be generated in response to the prompts—that train the pre-trained model 102a to recognize the types of responses that should be generated in response to various types of prompts. This training, which adjusts the weights and biases of the model 102a, transforms the pre-trained model 102a to a fine-tuned model 102b that is better suited to the application domain in which the model 102b will be used. Training a pre-trained model 102a using training data comprising prompt-response pairs to yield a fine-tuned model 102b is also referred to as instruction tuning. The resulting fine-tuned model 102b can be deployed to, and executed within, an application and used to generate responses 108 to human prompts 106 submitted to the application.

In some application domains, the fine-tuned model 102b may be required to tailor its responses 108 to adhere to various pillars of interest or human preferences. These preferences may include, for example, ensuring that the responses 108 are free of biased or toxic language, maximizing legibility of the responses 108, minimizing misinformation, or other such preferences. The process of training the fine-tuned model 102b to generate responses that comport with these preferences is referred to as alignment. Improperly aligned models 102b may be susceptible to hallucinations, excessive bias or toxicity in the generated responses 108, or otherwise inaccurate or undesirable answers to prompts 106.

Some current alignment methods, such as supervised fine-tuning (SFT), reinforcement learning from human feedback (RLHF), and direct preference optimization (DPO), have significant drawbacks in terms of the expense, labor, and performance. For example. RLHF and DPO require large sets of carefully annotated human preference data and feedback, as well as expensive iterative training of multiple models (e.g., reward models, preference models, policy models, policy base models, etc.). These approaches require human trainers to collect or write prompt-response pairs demonstrating the human intentions or preferences to which the model 102b should align its responses 108, and also demonstrating how to respond to certain types of prompts 106 in a manner that aligns with the preferences (e.g., mitigation of toxicity, bias, or misinformation). SFT, while increasing the likelihood that the model 102b will generate responses 108 that align with human preferences (or aligned responses), does not produce a model 102b that actively suppresses responses 108 that do not align with those preferences (or misaligned responses).

To address these and other issues, one or more embodiments described herein are directed to systems and methods for aligning a language model to human preferences by automatically generating alignment data and training the model using this alignment data. This approach, referred to herein as contrastive fine-tuning (CFT), simultaneously increases the likelihood of helpful, human-aligned responses while actively decreasing the likelihood of harmful or misaligned responses. This contrasts with standard SFT, which only increases the likelihood of aligned responses without controlling for response misalignment. According to CFT, a separate negative model is trained to behave as a “negative persona” using datasets of human-misaligned responses, or responses that do not align with the human preferences for which the base model is being trained. The trained negative model is then used to generate training data comprising misaligned responses paired with corresponding prompts, and the resulting training data is used to train the base model on the unlikelihood objective. The CFT approach described herein reduces or eliminates the need for expensive human feedback during the model training process and does not require expensive teaching models, and is therefore a simple and effective alignment technique for training language models to generate responses that adhere to human values and preferences across diverse tasks Language models trained using the CFT approach suppress misaligned responses more effectively than SFT alone.

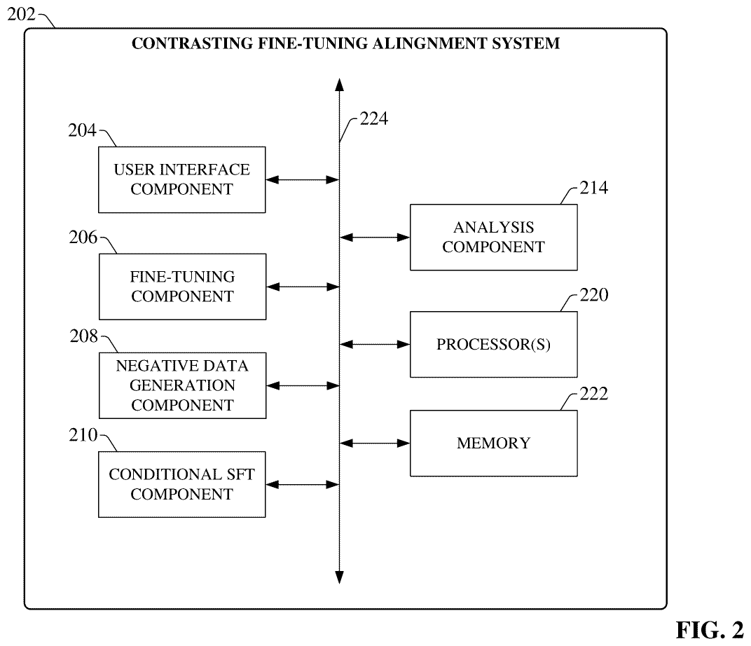

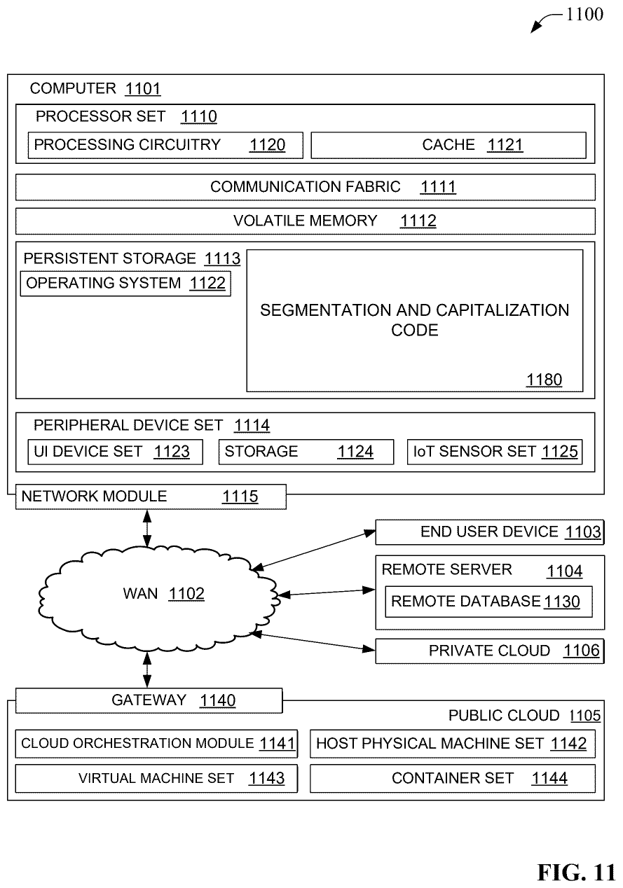

The embodiments depicted in one or more figures described herein are for illustration only, and as such, the architecture of embodiments is not limited to the systems, devices and/or computer-implemented operations depicted therein, nor to any particular order, connection or coupling of systems or devices depicted therein. For example, in one or more embodiments, the non-limiting systems described herein such as non-limiting system 202 as illustrated at FIG. 2, or systems thereof, further comprise, are associated with, or are coupled to one or more computer or computing-based elements described herein with reference to an operating environment, such as the operating environment 1100 illustrated at FIG. 11. For example, in one or more embodiments, non-limiting system 202 is associated with, such as accessible via, a computing environment 1100 described below with reference to FIG. 11, such that aspects of processing are distributed between non-limiting system 202 and the computing environment 1100. In one or more described embodiments, computer and/or computing based elements are used in connection with implementing one or more of the systems, devices, or computer-implemented operations shown or described in connection with FIG. 2 or with other figures described herein.

FIG. 2 is a block diagram of an example, non-limiting contrasting fine-tuning (CFT) alignment system 202. System 202 includes memory 222 for storing computer-executable components and one or more processors 220 operably coupled via one or more communication busses 224 to memory 222 for executing the computer-executable components stored in memory 222. As shown in FIG. 2, the computer-executable components include a user interface component 204, a fine-tuning component 206, a negative data generation component 208, a conditional SFT component 210, and an analysis component 214.

User interface component 204 can receive user input and render output to the user in any suitable format (e.g., visual, audio, tactile, etc.). In some embodiments, user interface component 204 can be configured to communicatively interface with a client device (e.g., a laptop computer, tablet computer, smart phone, etc.) via a hardwired or wireless connection. The user interface component 204 can then serve suitable interface displays to a client device and exchange data via these interface displays. Input data that can be received via various embodiments of user interface component 204 can include, but is not limited to, selection inputs that select a language model or model type to be tuned, control inputs directed to a language model tuning process (e.g., instructions to start or stop generation of training data or a model training sequence), inputs that select and import training datasets for training a base model or a negative model, natural language prompts directed to a CFT-tuned model, instructions to export a CFT-tuned model to an external system or application, or other such inputs. Output data rendered by various embodiments of user interface component 204 can include, but is not limited to, responses generated by the CFT-tuned model in response to natural language prompts submitted by the user, status information for the model tuning process, or other such outputs.

Fine-tuning component 206 can be configured to perform supervised fine-tuning on a base model using aligned training data, and on a separate negative model using misaligned, or negative, training data. The fine-tuning component 206 can also be configured to perform subsequent unlikelihood-based training on the base model using both aligned and misaligned training data. Negative data generation component 208 can be configured to use the trained negative model to generate negative training data to be used by the fine-tuning component 206 to perform the unlikelihood-based training on the base model. Conditional SFT component 210 can be configured to perform conditional SFT tuning on the base model that trains the model how to process one or more types of problematic questions or prompts in a prosocial manner. Analysis component 214 can be configured to process natural language prompts submitted to the system 202 and to generate responses to those prompts using the CFT-tuned model.

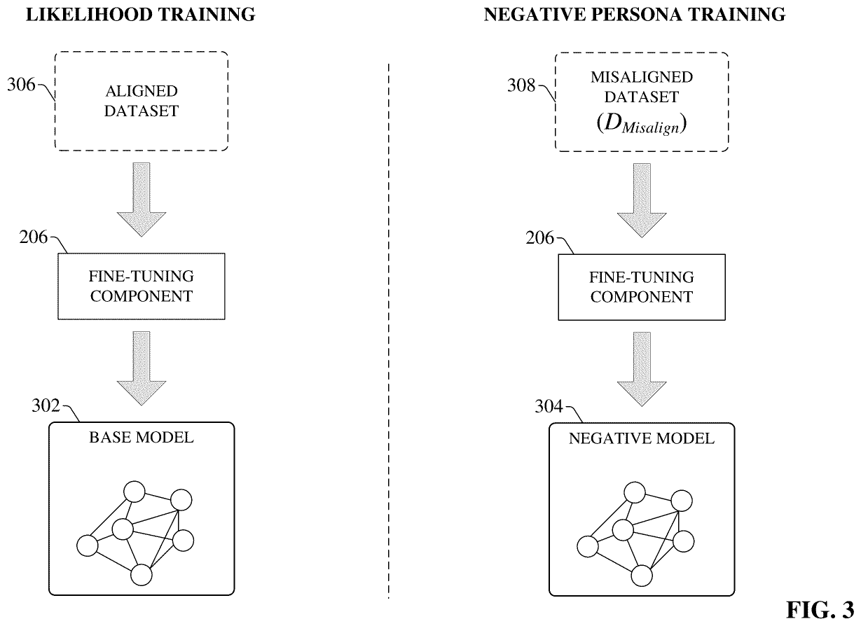

The general steps for performing contrastive fine-tuning will now be described. FIG. 3 is a diagram illustrating training of a base model 302 and a negative model 304 using supervised fine-tuning. At a high level, CFT performs both likelihood training and unlikelihood training on a base model 302 (e.g., an LLM or another type of a pre-trained model) to yield a final fine-tuned model 302 that both increases the likelihood of aligned responses while actively minimizing the likelihood of misaligned responses. In general, an aligned response is one deemed both helpful and in alignment with response preferences for which the base model 302 is trained (e.g., free of toxicity, bias, or misinformation), while a misaligned response is one that violates the response preferences. Example human preferences to which the base model 302 can be aligned can include, but are not limited to, ensuring that the model's responses do not contain biased or toxic language or words, maximizing legibility of the responses, ensuring that the responses do not contain misinformation or copywrite violations, preventing responses that contain potentially harmful information (e.g., instructions on how to design weaponry), or other such preferences.

Initially, the system 202 performs likelihood training on the pre-trained base model 302, as shown on the left side of FIG. 3. A fine-tuning component 206 can perform supervised fine-tuning on the base model 302 using an aligned dataset 306 comprising sample data that is aligned to the preferred types of responses. The aligned dataset 306 may comprise, for example, a set of prompt-response pairs comprising example natural language prompts paired with corresponding responses to those prompts that are in alignment with the preferences for which the model 302 is to be trained. The aligned dataset 306 trains the model 302 to recognize characteristics of aligned responses for various types of example prompts. In some likelihood training scenarios, the aligned dataset 306 can include examples that train the model 302 on various types of tasks, such as open-ended question-and-answer, information extraction, math problems, coding problems, Chain of Thought examples, or other such tasks.

This likelihood training improves the helpfulness of the model 302 by improving zero shot generalization on instructions. After this initial likelihood training, the base model 302 is capable of generating aligned responses to prompts but may still be capable of generating harmful or misaligned responses if elicited by certain prompts. This is because supervised fine-tuning only increases the likelihood aligned responses but does not control the likelihood of misaligned responses.

To reduce the likelihood of misaligned responses, the system performs a further process of unlikelihood training on the base model 302 using a negative dataset comprising examples of misaligned responses. To generate this negative dataset without the need for expensive human feedback or annotation, the system 202 can train a separate negative model 304 to generate misaligned responses to prompts, as depicted on the right side of FIG. 3. The fine-tuning component 206 can train this negative model 304 using a misaligned dataset 308 (D_{Misalign}) comprising examples of responses that violate the response preferences. The misaligned dataset 308 may comprise, for example, a set of prompt-response pairs comprising example natural language prompts paired with corresponding responses to those prompts that are in violation of the preferences for which the base model 302 is to be trained (or “negative responses”). In general, responses that are deemed negative, or in violation of the human preferences for which the base model 302 is being trained, will depend on the specific tasks that the base model 302 will be carrying out, or the type of application in which the base model 302 will be used. Depending on the application or use case, misaligned or negative responses may be responses that contain biased or toxic language, misinformation, verboten words or phrases, language that violates copywrite, potentially harmful information, or other such types of content. The system 202 can allow the user to select or import misaligned dataset 308 that includes only examples of these negative responses, paired with example prompts that would invoke these responses. Collectively, the samples included in the misaligned dataset 308 exemplify the types of responses that the base model 302 is to be taught to avoid.

The fine-tuning component 206 performs supervised fine-tuning of the negative model 304 using this misaligned dataset 308, thereby training the negative model 304 to generate misaligned responses to prompts; that is, responses of a type that the base model 302 is to be prevented from generating. This approach leverages the negative model's ability to not only understand the intent of instructions but also mimic the style of the example responses when answering user questions. Performing supervised fine-tuning on the negative model 304 using a misaligned dataset 308 made up of sample responses that the base model 302 should avoid teaches the negative model 304 to generalize the negative response style over any input instruction and to produce responses that seem to be coming from a negative persona that deliberately violates the response preferences.

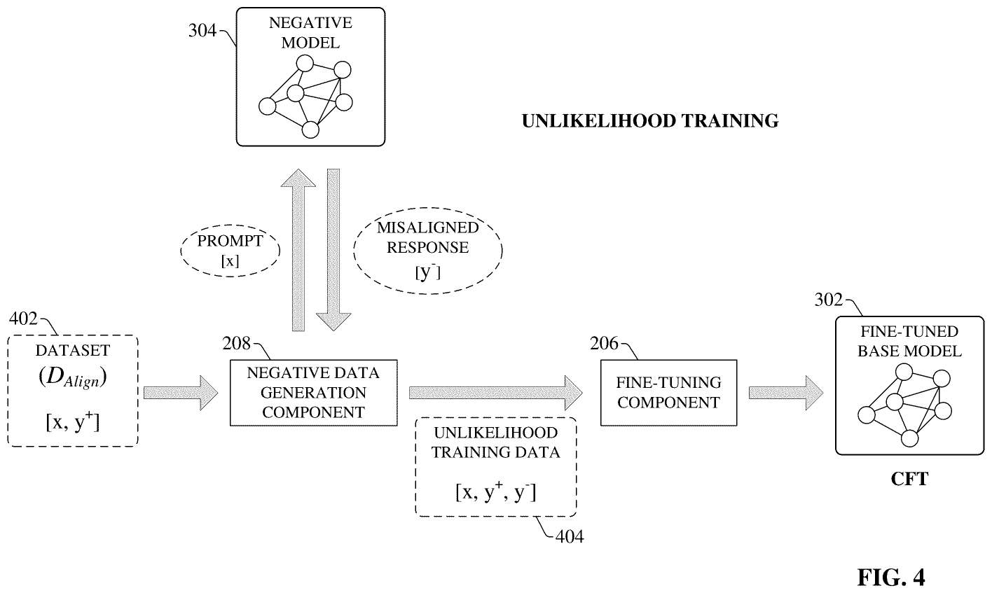

Once the negative model 304 has been trained using the misaligned dataset 308, the negative model 304 can be used to generate a larger set of negative data, which is used to perform unlikelihood training on the base model 302. FIG. 4 is a diagram illustrating generation and use of this negative data to perform unlikelihood training on the base model 302. To generate the unlikelihood training data 404 that will be used to perform contrastive training of the base model 302, the user can prepare, select, or import a dataset 402 (D_{Align}) comprising sample prompts x paired with corresponding aligned responses y⁺ that are in alignment with the response preferences (that is, answers to the prompts x that are considered good answers), and the system's negative data generation component 208 can submit the prompts x from this dataset 402 to the negative model 304 for processing. In some scenarios, the aligned dataset 402 can be the same dataset 306 used to perform the initial supervised fine-tuning on the base model 302. However, the user may alternatively choose to use a different available aligned dataset 402 for this step.

Since the negative model 304 has been trained to generate misaligned responses to prompts, the negative model 304 will, for each submitted prompt x from the aligned dataset 402, generate a misaligned response y⁻ that simulates the response style of a negative persona (that is, a persona that responds to prompts in a manner that the base model 302 is to be trained to avoid). The negative data generation component 208 generates the unlikelihood training data 404 by pairing each misaligned response y⁻ generated by the negative model 304 with the corresponding prompt x that gave rise to the misaligned response y⁻ and the aligned response y⁺ already paired with that prompt x. This yields a set of unlikelihood training data 404 in which each sample prompt x is associated with both an aligned (y⁺) and a misaligned (y⁻) version of the response to that prompt x.

Once the negative data generation component 208 has completed generation of the unlikelihood training data 404 using the misaligned responses y⁻ generated by the negative model 304, the fine-tuning component 206 trains the base model 302 using the resulting unlikelihood training data 404. This training teaches the base model 302 to upweigh or prioritize responses characterized by the aligned responses y⁺ and to suppress responses characterized by the misaligned or negative responses y⁻, thus improving the likelihood that the base model 302 will generate aligned responses while reducing the likelihood that the base model 302 will generate misaligned responses that violate the preferences for which the base model 302 is being trained. In general, this unlikelihood training teaches the base model 302 to satisfy a maximization problem represented by:

$${max}_{θ} {𝔼}_{x ∼ {D}_{Align}} [ {𝔼}_{{y}^{+} ∼ {p}_{y \vert x}^{+}} [ log {p}_{θ} ( {y}^{+} \vert x ) ] + {β𝔼}_{{y}^{-} ∼ {p}_{y \vert x}^{-}} [ log ( 1 - {p}_{θ} ( {y}^{-} \vert x ) ) ] ] \qquad ( 1 )$$

The objective outlined by equation (1) aims to simultaneously minimize the likelihood of misaligned responses (negative data) while maximizing the likelihood of aligned responses (positive data). A challenge in achieving this objective is in obtaining a negative data distribution

$${p}_{x \vert y}^{-}$$

that can generate negative data y⁻ conditioned on a prompt x from an aligned dataset D_{Align} (dataset 402). The aim of the negative data distribution

$${p}_{x \vert y}^{-}$$

is to generate misaligned responses y⁻ that closely resemble aligned responses y⁺ for the same prompt x. The contrastive fine-tuning alignment system 202 described herein obtains such misaligned responses y⁻ by using supervised fine-tuning to tune the negative model 304 on the misaligned dataset 308 (D_{Misalign}). This misaligned dataset 308 can comprise publicly accessible or specially designed misaligned demonstration datasets that train the negative model's “negative persona,” which impersonates a negatively-biased human who provides only misaligned responses y⁻. The resulting negative model 304 is instruction-following but with harmful bias, and therefore generates misaligned responses y⁻ that closely resemble the corresponding aligned responses y⁺ for the same given prompt x from the aligned dataset 402 (D_{Align}). Using this approach, the system 202 can generate a large amount of misaligned responses y⁻ for the unlikelihood training data 404 without the need for time- and labor-consuming human annotation. As part of the unlikelihood tuning, the fine-tuning component 206 also tunes the beta parameter β in equation (1), which controls the weighing of the unlikelihood response.

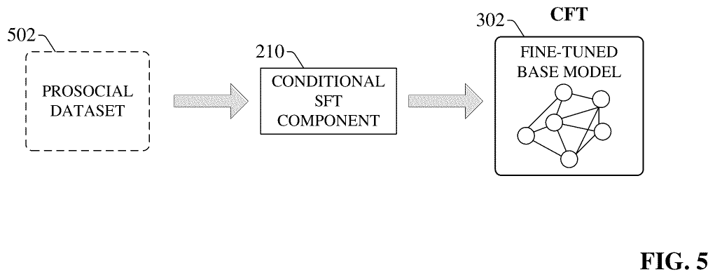

In addition to the unlikelihood tuning described above, some embodiments of the CFT alignment system 202 can also execute an additional social dialog tuning cycle that teaches the base model 302 how to respond to socially problematic or unethical prompts in a prosocial manner, thereby further improving the harmlessness of the model 302. FIG. 5 is a diagram illustrating social dialog tuning according to one or more embodiments. The system's conditional SFT component 210 can perform conditional supervised fine-tuning (conditional-SFT) on the base model 302 using a prosocial dataset 502 comprising examples of potentially problematic prompts together with corresponding responses that encourage prosocial behavior, grounded in common sense social norms or rules. Example problematic prompts that can be represented in the prosocial dataset 502 include requests for information that can empower the user to do harm to people, property, or systems (e.g., instructions for building a destructive device, instructions for hacking into a restricted computer system or into the model 302 itself, etc.). The example responses to these prompts included in the prosocial dataset 502 teach the base model 302 how to respond to various types of such problematic prompts in a prosocial and harmless manner. Performing conditional supervised fine-tuning on the base model 302 using this prosocial dataset 502 further reduces the model's potential for harmful behavior.

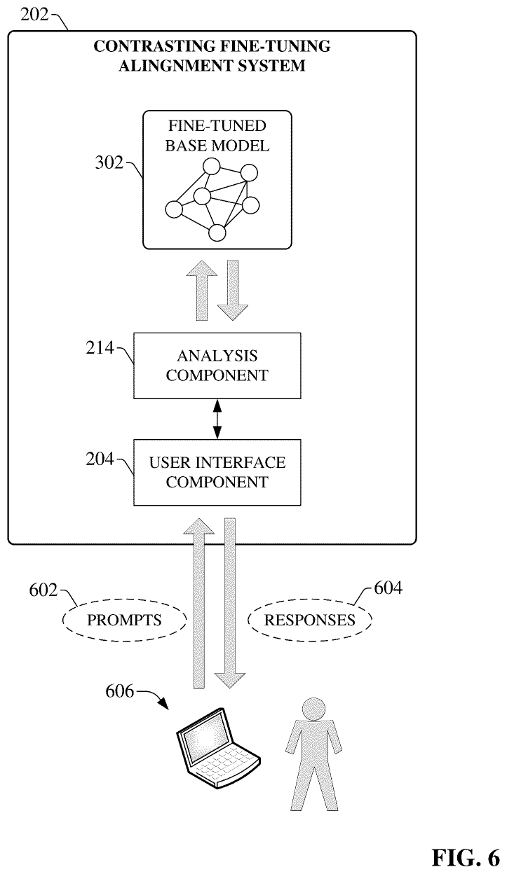

Once the system 202 has completed contrastive fine-tuning of the base model 302 using the unlikelihood training data 404 (and, optionally, has completed conditional supervised fine-tuning on the model 302 using the prosocial dataset 502), the resulting fine-tuned model 302 can be deployed to any NLP application or system for which the model 302 was tuned and used to process natural language inputs in accordance with the model's training. FIG. 6 is a diagram illustrating submission and processing of prompts 602 by the fine-tuned base model 302. Fine-tuned models 302 generated by embodiments of system 202 can be deployed to, and stored on, the hardware storage medium of substantially any type of computerized system as part of an NLP application that executes on that system. The computerized system's processing components can execute the model 302 during runtime of the NLP application, causing the model 302 to process natural language prompts 602 submitted to the application and to generate natural language responses 604 to those prompts based on this processing.

In the illustrated example, natural language prompts 602 are submitted to the system 202 itself for processing by the model 302. However, as noted above, the model 302 can be deployed to substantially any external application or system and used to perform natural language processing for those external applications. The system's user interface component 204 can generate and render a user interface on a client device 606 (e.g., a laptop or desktop computer, a mobile personal device, a tablet computer, an augmented reality device, etc.) through which the user can submit natural language prompts 602 to the system 202 in the form of natural language text or spoken input. An analysis component 214 can submit the prompt 602 to the CFT-tuned model 302 for processing, performing any necessary pre-processing on the received prompt 602 prior to submission to the model 302 (e.g., removal of redundant information, contextual labeling, rephrasing, etc.). The contrastive fine-tuned model 302 generates a natural language response 604 to the prompt 602 in accordance with the model's training as described above in connection with FIGS. 3-5, and the user interface component 204 renders this response 604 on the client device 606 via the user interface.

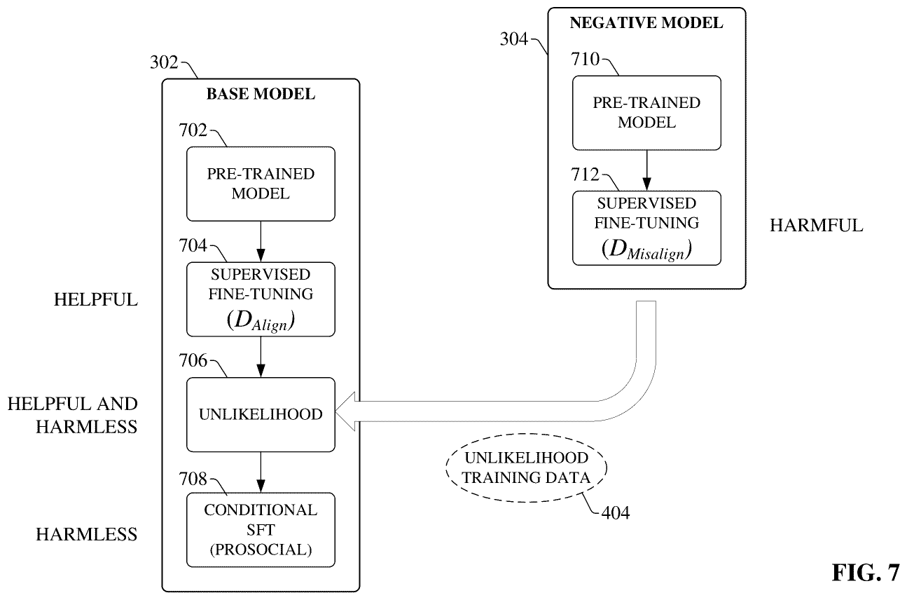

FIG. 7 is a diagram of a contrastive fine-tuning alignment pipeline

summarizing the contrastive fine-tuning approach carried out by embodiments of the system 202. As described above, the contrastive fine-tuning alignment system 202 trains a base model 302 using unlikelihood training data 404 comprising misaligned responses y⁻ generated by a separate negative model 304 that has been trained to respond to prompts as a negative persona. To obtain the trained base model 302, the system 202 (e.g., the system's fine-tuning component 206) performs supervised fine-tuning on a pre-trained language model 702 using an aligned dataset 306 comprising example data that is aligned to the preferred types of responses (as described above in connection with FIG. 3). This improves the helpfulness of the base model 302b by improving zero shot generalization on instructions. However, this supervised fine-tuning alone does not train the model 302 to actively suppress harmful or misaligned responses.

To improve both the helpfulness and harmlessness of the base model 302, the system 202 creates the separate negative model 304 (e.g., using the fine-tuning component 206) by performing supervised fine-tuning 712 on another pre-trained language model 710, as described above in connection with FIG. 3. This supervised fine-tuning 712 is performed using a misaligned dataset 308 (D_{Misalign}) comprising examples of responses that are considered negative or harmful; that is, examples of the types of responses that the base model 302 is to be trained to avoid or suppress. The system 202 (e.g., the system's negative data generation component 208) then uses this trained negative model 304 to generate negative data in the form of misaligned responses y⁻ to sample prompts x, and pairs these misaligned responses y⁻ with their corresponding aligned responses y⁺ and sample prompts x to yield unlikelihood training data 404, as described above in connection with FIG. 4. The system 202 (e.g., the system's fine-tuning component 206) then performs unlikelihood training 706 on the base model 302 using the resulting unlikelihood training data 404, as also described above in connection with FIG. 4. This unlikelihood training improves both the helpfulness and the harmlessness of the base model 302 by teaching the model 302 to recognize, and actively upweigh, responses that conform to the preferred response style (characterized by aligned responses y⁺), and also to recognize, and actively suppress, responses that are in the style of the misaligned responses y⁻.

Finally, the system 202 performs conditional supervised fine-tuning 708 on the base model 302 (e.g., using the conditional SFT component 210) using a prosocial dataset 502, as described above in connection with FIG. 5. This further improves the harmlessness of the base model 302 by encouraging prosocial behavior and teaching the model 302 to respond in a harmless manner to potentially problematic or unethical prompts.

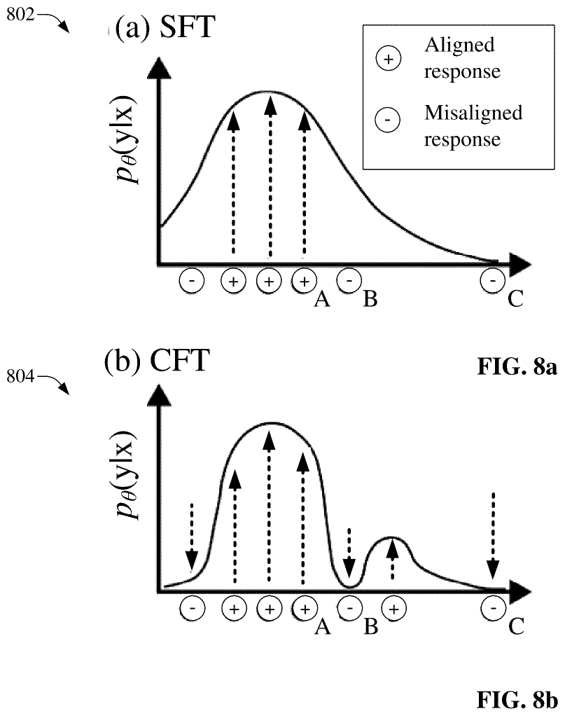

Experimental results demonstrate that CFT improves model alignment by enhancing harmlessness without sacrificing helpfulness or degrading other capabilities, such as question answering. FIG. 8a is a plot 802 of a probability distribution p_{θ}(y|x) for an example set of aligned and misaligned responses generated by a language model trained using only supervised fine-tuning (without using the contrastive fine-tuning alignment approach described herein). FIG. 8b is another plot 804 of a probability distribution p_{θ}(y|x) for an example set of aligned and misaligned responses generated by the model 302 trained using contrastive fine-tuning alignment as described above. As can be seen in plot 802, while the model trained solely using supervised fine-tuning improves the probability of outputting an aligned responses, some misaligned responses that are sufficiently similar to an aligned response—such as misaligned response B, which is similar to aligned response A—may still be output by the model since the boundary between the aligned response A and misaligned response B is indistinct. That is, the purely SFT-trained model does not actively reduce the probability of outputting a misaligned response.

By contrast, as can be seen in plot 804, since the contrastive fine-tuned model 302 has been trained with a dataset of unlikelihood training data 404 comprising pairs of similar aligned and misaligned responses to respective sample prompts, the model 302 is better able to recognize the style of responses that are to be avoided and actively reduce the probability of outputting such misaligned responses. The strength of suppression of misaligned responses can be controlled by the beta parameter β in equation (1), which is tuned by the fine-tuning component 206 as part of the unlikelihood training. By training the model 302 using pairs of aligned responses y⁺ and misaligned responses y⁻ that are similar to one another (represented by unlikelihood training data 404), the system 202 renders the boundaries between aligned and misaligned responses more distinct, allowing the model 302 to more successfully recognize and suppress misaligned responses.

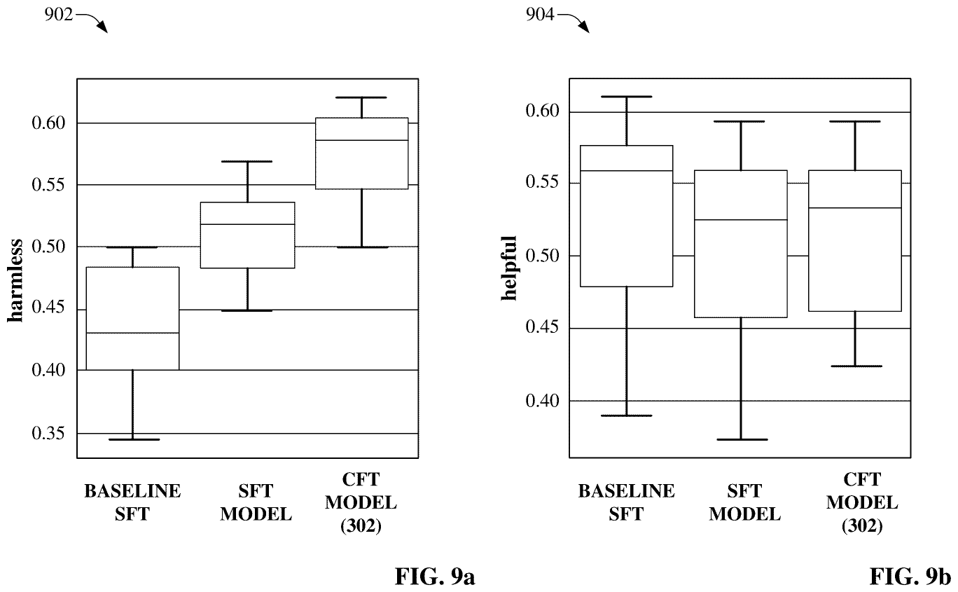

FIG. 9a is a graph 902 that graphs measured levels of harmlessness of three example models—a baseline SFT model, an SFT model that has been further fine-tuned using supervised fine-tuning, and a CFT model (e.g., a model 302) that has been further fine-tuned using the contrastive fine-tuning alignment approach applied by system 202. FIG. 9b is another graph 904 that graphs measured levels of helpfulness of the three example models. Graphs 902 and 904 depict the median harmlessness and helpfulness (the horizontal lines) and the quantiles for harmlessness and helpfulness (the boxes) for each of the three example models. As can be seen in graph 902 and 904, the CFT model 302 demonstrates significantly higher harmlessness compared to the SFT models without compromising on helpfulness. This suggests that contrastive fine-tuning alignment effectively enhances the alignment of a language model without incurring alignment taxes. Moreover, the variance of the helpfulness score for the CFT model is lower than that of the two SFT models, suggesting that contrastive fine-tuning alignment provides the additional benefit of making the language model more resilient to positional biases.

Some embodiments of the contrastive fine-tuning alignment system 202 can use CFT in conjunction with other training methods, such as RLHF. For example, the system can use CFT to reinforce learning from human feedback and improve alignment of the model 302 before applying RLHF.

By training a separate negative language model to respond to prompts as a negative “persona” and using this negative model to generate a dataset of misaligned responses with which to train the base language model, the contrastive fine-tuning alignment system and method described herein can train a language model to align its responses to human preferences without the need for expensive human feedback during the training phase, thus offering a simpler and more effective model alignment approach relative other methods such as SFT, RLHF, or DPO. The resulting CFT-tuned model demonstrates improved alignment over other tuning approaches, such as the use of SFT alone, by actively suppressing misaligned or harmful responses in addition to promoting aligned responses, thus improving both helpfulness and harmlessness of the model.

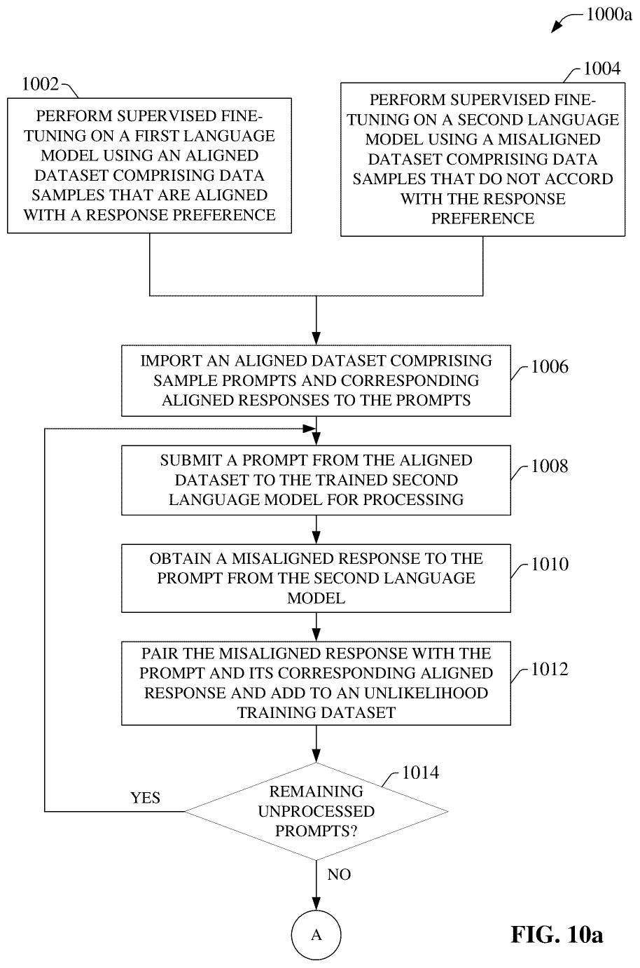

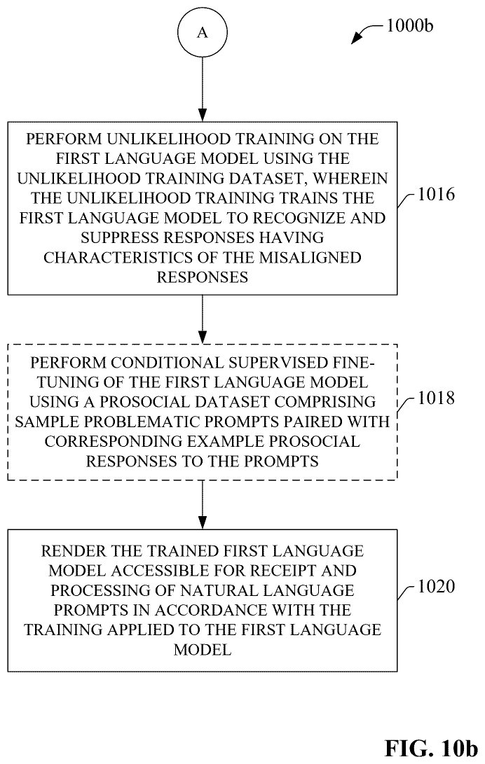

FIGS. 10a-10b illustrate a methodology in accordance with one or more embodiments of the subject application. While, for purposes of simplicity of explanation, the methodology shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 10a illustrates a first part of an example methodology 1000a for performing contrastive fine-tuning alignment on a language model. At 1002, supervised fine-tuning is performed on pretrained first language model (e.g., by the fine-tuning component 206) using an aligned dataset comprising data samples that are aligned with a response preference. The aligned dataset can exemplify substantially any type of response preference to which the first language model is to be aligned, including but not limited to eliminating biased or socially toxic content from the model's responses, maximizing response legibility, eliminating misinformation or copywrite violations from the responses, or other such response preferences.

Separately, at step 1004, supervised fine-tuning is performed a second language model (e.g., by the fine-tuning component 206) using a misaligned dataset comprising data samples that do not accord with the response preference for which the first language model is to be trained. The misaligned dataset may comprise, for example, sample natural language prompts paired with corresponding responses to those prompts that violate the response preferences for which the first language model is to be trained; that is, responses exemplifying the types of responses that the first language model is to be trained to avoid or suppress.

At 1006, an aligned dataset comprising sample prompts and corresponding aligned responses to the sample prompts is imported (e.g., by the fine-tuning component 206). The aligned responses contained in this dataset accord with the response preferences to which the first language model is to be aligned. In some scenarios, this aligned dataset may be the same dataset used in step 1002 to perform initial supervised fine-tuning of the first language model. However, a different dataset comprising prompt-response pairs may also be used for this step. This dataset will be used to generate negative training data for contrastive fine-tuning alignment of the first language model.

At 1008, a prompt from the aligned dataset imported at step 1006 is submitted to the second language model that was trained at step 1004 for processing (e.g., by the negative data generation component 208). At 1010, a misaligned response to the prompt that was processed at step 1008 is obtained from the second language model (e.g., by the negative data generation component 208). Since the second language model was trained, using the misaligned dataset, to respond to prompts in a manner to be avoided by the first language model, the misaligned response represents an undesirable version of the response to the prompt, in contrast to the aligned version of the response included in the aligned dataset. At 1012, the misaligned response obtained at step 1010 is paired with the prompt and the prompts corresponding aligned response, and the prompt is added to an unlikelihood training dataset together with its aligned and misaligned responses (e.g., by the negative data generation component 208).

At 1014, a determination is made (e.g., by the negative data generation component 208) as to whether the aligned dataset imported at step 1006 includes remaining unprocessed prompts. If the aligned dataset includes prompts that have not yet been processed by the second language model (YES at step 1014), the methodology returns to step 1008, and steps 1008-1012 are repeated for one of the remaining unprocessed prompts.

When misaligned responses have been obtained for all prompts of the aligned dataset (NO at step 1014), the methodology proceeds to the second part 1000b illustrated in FIG. 10b. At 1016, unlikelihood training is performed on the first language model using the unlikelihood training dataset generated by steps 1006-1014 of the methodology (e.g., by the fine-tuning component 206). This unlikelihood training trains the first language model to recognize and suppress responses having characteristics of the misaligned responses included in the unlikelihood training dataset, while improving the likelihood of aligned responses.

At optional step 1018, conditional supervised fine-tuning of the first language model is performed (e.g., by the conditional SFT component 210) using a prosocial dataset comprising sample problematic prompts paired with corresponding example prosocial responses to the prompts. This conditional supervised fine-tuning can train the first language model to generate harmless and prosocial responses to prompts that may otherwise illicit harmful content from the first language model, such as requests for information that can be used to harm people or systems.

At 1020, the first language model, as trained using the preceding steps, is rendered accessible for receipt and processing of natural language prompts in accordance with the training. For example, the trained first language model can be deployed to an NLP application and used to process natural language inputs submitted by users or other systems within the context of that application's functions.

Embodiments of the contrasting fine-tuning alignment system 202 described herein yield technical improvements over other types of language model tuning and alignment systems by training language models to actively suppress misaligned responses that do not conform with a preferred response style (in contrast to systems that rely solely on supervised fine-tuning), and by generating the negative training data required for this training without the need for time-and labor-consuming human feedback or data annotation to convey the human intentions to which the model is to be aligned (in contrast to systems that train language models using RLHF). As indicated by the test results depicted in FIGS. 9a and 9b, language models trained using embodiments of system 202 demonstrate improved response harmlessness relative to models trained by systems that use other training approaches, without significant reduction in the helpfulness of the model's responses.

It is noted that the creation and training of language models to generate automated natural language responses to natural language prompts is a technical function that cannot be performed by the human mind alone. In this regard, the human mind alone cannot generate any type of deployable language model capable of execution by a computer system's processing components to facilitate processing of natural language prompt inputs and generation of natural language responses to those prompt inputs. Rather, creating and training of such fine-tuned language models only have meaning in the context of computer hardware-and software-based language model development and training platforms, and therefore cannot be divorced from the hardware and software environments that realize such platforms. As such, the functions of the contrasting fine-tuning alignment system 202 described herein do not represent mere abstract mental processes that are only nominally tied to a computer environment via claim language. Rather, these functions are inextricably linked to computer technology, such that the functions cannot be separated from computer hardware environments without rendering these functions meaningless.

FIG. 11 and the following discussion are intended to provide a brief, general description of a suitable computing environment 1100 in which one or more embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as translation of an original source code based on a configuration of a target system by the fingerprint generation code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180), as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method can be distributed among multiple computers and/or between multiple locations. On the other hand, in this presentation of computing environment 1100, detailed discussion is focused on a single computer, specifically computer 1101, to keep the presentation as simple as possible. Computer 1101 can be located in a cloud, even though it is not shown in a cloud in FIG. 11. On the other hand, computer 1101 is not required to be in a cloud except to any extent as can be affirmatively indicated.

PROCESSOR SET 1110 includes one, or more, computer processors of any type now known or to be developed in the future. Processing circuitry 1120 can be distributed over multiple packages, for example, multiple, coordinated integrated circuit chips. Processing circuitry 1120 can implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set can be located “off chip.” In some computing environments, processor set 1110 can be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods can be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory can be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 can be a read only memory (ROM), but typically at least a portion of the persistent storage allows writing of data, deletion of data and re-writing of data. Some familiar forms of persistent storage include magnetic disks and solid-state storage devices. Operating system 1122 can take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 can include components such as a display screen, speaker, microphone, wearable devices (such as goggles and smart watches), key board, mouse, printer, touchpad, game controllers, and haptic devices. Storage 1124 is external storage, such as an external hard drive, or insertable storage, such as an SD card. Storage 1124 can be persistent and/or volatile. In some embodiments, storage 1124 can take the form of a quantum computing storage device for storing data in the form of qubits. In embodiments where computer 1101 is required to have a large amount of storage (for example, where computer 1101 locally stores and manages a large database) then this storage can be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor can be a thermometer and another sensor can be a motion detector.

NETWORK MODULE 1115 is the collection of computer software, hardware, and firmware that allows computer 1101 to communicate with other computers through WAN 1102. Network module 1115 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and can take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 can be a client device, such as thin client, heavy client, mainframe computer and/or desktop computer.

REMOTE SERVER 1104 is any computer system that serves at least some data and/or functionality to computer 1101. Remote server 1104 can be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data can be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs can be stored as images and can be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software. hardware and firmware allowing public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares. CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1103 and private cloud 1106 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, the executable components comprising:
a negative data generation component configured to generate, using a first language model trained to generate misaligned natural language responses to natural language prompts, misaligned natural language responses to sample natural language prompts, and to generate unlikelihood training data comprising the misaligned natural language responses, wherein the misaligned natural language responses violate a response preference to which a second language model is to be aligned; and
a tuning component configured to train the second language model, using the unlikelihood training data, to generate responses that align with the response preference.

2. The system of claim 1, wherein the fine-tuning component is configured to perform supervised fine-tuning on the first language model that trains the first language model to generate the misaligned natural language responses to the natural language prompts.

3. The system of claim 2, wherein the fine-tuning component is configured to perform the supervised fine-tuning on the first language model using a misaligned dataset comprising sample misaligned natural language responses that violate the response preference.

4. The system of claim 1, wherein the negative data generation component is configured to generate the misaligned natural language responses using the first language model and an aligned dataset comprising the sample natural language prompts and corresponding aligned natural language responses that align with the response preference.

5. The system of claim 4, wherein the negative data generation component is configured to generate the unlikelihood training data to include the misaligned natural language responses, the sample natural language prompts, and the aligned natural language responses.

6. The system of claim 1, wherein the response preference specifies that the second language model is to generate responses that at least one of omit biased, omit toxic language, omit misinformation, maximize legibility, omit language that violates a copywrite, or omits harmful information.

7. The system of claim 1, further comprising a conditional supervised fine-tuning (SFT) component configured to perform conditional fine-tuning on the second language model using a prosocial dataset comprising sample problematic prompts and corresponding prosocial natural language responses to the sample problematic prompts.

8. The system of claim 7, wherein the sample problematic prompts comprise requests for information that facilitate harm to a person, a system, or property.

9. The system of claim 1, wherein training of the second language model by the fine-tuning component using the unlikelihood training data causes the second language model to suppress generation of responses that do not align with the response preference in response to prompts submitted to the second language model.

10. The system of claim 1, further comprising
a user interface component configured to render a user interface on a client device and to receive, via interaction with the user interface, a natural language prompt; and
an analysis component configured to submit the natural language prompt to the second language model and to obtain a natural language response to the prompt generated by the second language model based on processing of the natural language prompt,
wherein the user interface component is further configured to render the natural language response on the user interface.

11. A computer-implemented method, comprising:
generating, by a system comprising a processor and using a first language model trained to generate misaligned natural language responses to natural language prompts, misaligned natural language responses to sample natural language prompts, wherein the misaligned natural language responses characterize a response type that a second language model is to be trained to suppress;
generating, by the system, unlikelihood training data comprising the misaligned natural language responses; and
training, by the system, the second language model, using the unlikelihood training data, to suppress responses corresponding to the response type.

12. The computer-implemented method of claim 11, further comprising performing, by the system, supervised fine-tuning on the first language model that trains the first language model to generate the misaligned natural language responses to the natural language prompts.

13. The computer-implemented method of claim 12, wherein the performing of the supervised fine-tuning comprises performing the supervised fine-tuning on the first language model using a misaligned dataset comprising sample misaligned natural language responses that violate the response preference.

14. The computer-implemented method of claim 11, wherein the generating of the misaligned natural language responses comprises generating the misaligned natural language responses using the first language model and an aligned dataset comprising the sample natural language prompts and corresponding aligned natural language responses that do not accord with the response type that the second language model is to be trained to suppress.

15. The computer-implemented method of claim 14, wherein the generating of the unlikelihood training data comprises generating the unlikelihood training data to include the misaligned natural language responses, the sample natural language prompts, and the aligned natural language responses.

16. The computer-implemented method of claim 11, wherein the response type that the second language model is to be trained to suppress is characterized by at least one of biased language, toxic language, misinformation, illegibility, language that violates a copywrite, or harmful information.

17. The computer-implemented method of claim 11, further comprising performing, by the system, conditional fine-tuning on the second language model using a prosocial dataset comprising sample problematic prompts and corresponding prosocial natural language responses to the sample problematic prompts.

18. The computer-implemented method of claim 17, wherein the sample problematic prompts comprise requests for information that facilitate harm to a person, a system, or property.

19. A computer program product comprising a computer-readable storage medium having program instructions embodied therewith, the program instructions executable by a processor to cause the processor to:
generate, by the processor using a first language model trained to generate misaligned natural language responses to natural language prompts, misaligned natural language responses to sample natural language prompts;
generate, by the processor, unlikelihood training data comprising the misaligned natural language responses, wherein the misaligned natural language response violate a response preference to which a second language model is to be aligned; and
train, by the processor, the second language model, using the unlikelihood training data, to generate responses that align with the response preference.

20. The computer program product of claim 19, further comprising performing, by the processor, supervised fine-tuning on the first language model using a misaligned dataset comprising sample misaligned natural language responses that violate the response preference, wherein the supervised fine-tuning trains the first language model to generate the misaligned natural language responses to the natural language prompts.
